(19) United States
(12) Patent Application Publication
(10) Pub. No.: US 2008/0204919 A1
(43) Pub. Date: Aug. 28, 2008

(54) Control device, storage device, and control method for storage device

(75) Inventors: Hidekazu Masuyama, Kawasaki-shi (JP); Kenichiro Suzuki, Kawasaki-shi (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/001,856

(22) Filed: Dec. 13, 2007

(30) Foreign Application Priority Data
Feb. 28, 2007 (JP) 2007-050367

(51) Int. Cl. G11B 15/18

(52) U.S. Cl. 360/69

(57) ABSTRACT

A storing unit stores initial parameters indicating initial values of control parameters in a first storage medium in association with first update parameters obtained by modifying the initial parameters. A difference detecting unit compares, when second update parameters are stored in a second storage medium, the initial parameters with the second update parameters, and detects a parameter that is different between the initial parameters and the second update parameters. An initialization unit initializes the first update parameters based on a result of detection by the difference detecting unit.

### BACKGROUND OF THE INVENTION

1. Field of the Invention

The present invention relates to a technology for controlling a storage device that performs data read and data write operations based on control parameters stored in a first storage medium or a second storage medium with an efficient updating of mode parameters.

2. Description of the Related Art

In recent years, due to the rapid increase in the amount of data handled by information processing systems, there is a trend towards higher capacities of storage devices (magnetic disk devices and the like). At the same time, the data handled by information processing systems is becoming increasingly important. For these reasons, the reliability of data read from and written to storage devices is being enhanced by various techniques.

Storage devices control their own operation based on mode parameters, and the reliability of the storage devices is affected by how these mode parameters are managed. The mode parameters contain data specifying the number of retries to perform when a read error occurs, and whether to perform caching during read. They may be classified into four types, i.e., a current value (Cur value), a changeable value (Chg value), a default value (Def value), and a save value (Sav value).

The Cur value is a parameter used when actually controlling the operation of a storage medium (disk). An upper-level device (a driver that controls a storage device or the like) can update the Cur value of the mode parameters.

The Chg value is a parameter showing that data contained in the mode parameters can be updated or that data cannot be updated. An upper-level device cannot update the Chg value of the mode parameters.

The Def value is a parameter showing the initial value (default value) of the mode parameters. The storage device temporarily uses the Def value after power has been switched on until the mode parameters stored on the disk are read. An upper-level device cannot update the Def value of the mode parameters.

The Sav value is a parameter that is actually stored when the mode parameters are stored in a nonvolatile storage medium (e.g., a disk) (the mode parameter stored on the disk, corresponds to the Sav value). It will be assumed that this Sav value coincides with the Cur value.

These various mode parameters are set or modified as explained hereafter from Power On (performed by the storage device when power supply to the storage device is started) to Drive Ready (performed by the storage device when the disk reaches a steady rotation velocity).

FIG. 12 is a diagram describing Power On and Drive Ready when the mode parameters of the conventional technology are used. When power is switched on, since the disk has not yet reached a steady rotation velocity, the storage device stores the Def value of the mode parameters in a firmware 10 such as a Flash Rom* or the like, in a Cur value field of a memory 20, copies it to a Def value field and a Sav value field, and stores the Chg value of the mode parameters in a Chg value field of the memory 20 (upper part of FIG. 12).

Until Drive Ready is performed, the storage device reads the Def value of the mode parameter stored in the Cur value field of the memory 20 to control its own operation. The Chg value and Def value are not modified in subsequent operations.

When the disk has reached a steady rotation velocity, the storage device shifts to Drive Ready. The storage device, when Drive Ready is performed, reads system information from a disk 30. The system information contains the mode parameters, and the storage device stores the Sav value of the mode parameters included in the system information, in the Cur value field and the Sav value field. The storage device reads the Sav value of the mode parameters stored in the Cur value field of the memory 20 to control its own operation.

However, an upper-level device can modify the mode parameters of the storage device by a Mode Select/Mode Select Extended command (hereafter, Mode Select Command). This Mode Select Command can specify whether to save the value of a mode parameter to the storage device after a modification contained in the Mode Select Command. Here, referring to FIG. 13, the operations performed when the Mode Select Command is issued to the storage device, will be explained for the case of “With Save” and “Without Save”. FIG. 13 is a diagram explaining the operations performed when the Mode Select Command is issued to the storage device.

The Mode Select Command is acquired from an upper-level device 40, and when “Without Save” is specified in the acquired Mode Select, the storage device stores the Cur value in the mode parameters of the Mode Select Command in the Cur value field of the memory 20 (FIG. 13).

In this case, since a mode parameter corresponding to the Mode Select Command is not stored in the disk 30, when power is switched off and the device is restarted, the storage device controls its own operation by a mode parameter stored on the disk 30.

On the other hand, when the Mode Select Command is acquired from the upper-level device 40 and “With Save” is specified in the acquired Mode Select, the storage device stores the Cur value in the mode parameters of the Mode Select Command in the Cur value field and the Sav value field of the memory 20 ((1) of FIG. 13). The storage device then stores the Cur value in the Sav value field in the mode parameters of the disk 30.

Hence, since the mode parameters corresponding to the Mode Select Command are stored on the disk 30, when power is switched off and the device is restarted, the storage device controls its own operation by referring to the mode parameters in the Mode Select Command.

The mode parameter (Cur value of the mode parameters) is set according to the usage environment; therefore, a different mode parameter is set depending on the client. Clients often request modification of the Def value of the mode parameters since it does not then have to be modified by the Mode Select Command. Moreover, as indicated in FIG. 12, since the Sav value of the mode parameters stored on the disk is selected with a higher priority than the Def value of the mode parameters stored in the firmware, if only the Def value of the mode parameters in the firmware were modified, the modification was not reflected in actual operation, so some way of reflecting it was required.

As a solution to this problem, when firmware was replaced in the conventional technology, information (hereafter, a customization code) for identifying the firmware was compared with a customization code for a new firmware, and if the two customization codes were different, the disk mode parameters were initialized to the Def value of the mode parameters (hereafter, updated mode parameters) in the new firmware.

FIG. 14 is a diagram explaining the initialization of mode parameters in a storage device according to the conventional technology. As shown in the diagram, when a difference in the customization code is detected, the storage device stores the Def value of the updated mode parameters in the Cur value field and the Sav value field of the memory 20 ((1) in FIG. 14). The storage device then stores the Def value in the Sav value field of FIG. 14 in the mode parameters of the disk 30 ((2) of FIG. 14). Hence, the storage device considered the updated mode parameters as valid by storing the Def value of the updated mode parameters on the disk 30.

In Japanese Patent Application Laid-open 2003-173546, a technique is disclosed where the start-up time of a storage device is reduced by reading control information used on the immediately preceding occasion when the storage device started up, and using control information read from a memory as an initial value during server adjustment.

In the conventional technology, when the mode parameters were updated, the customization codes in the mode parameters were compared, and if the two customization codes (customization code in the mode parameters prior to updating and customization code in the mode parameters after updating) were different, the mode parameters were forcibly initialized. However, this required downloading firmware to update the mode parameters, or modifying the source code of the downloaded firmware to match the specification of the mode parameters modified by the client prior to updating, and this was a burden on the client.

It was therefore an important problem to eliminate unnecessary operations when modifying mode parameters, and to lessen the burden on the client.

### SUMMARY OF THE INVENTION

It is an object of the present invention to at least partially solve the problems in the conventional technology.

A device according to one aspect of the present invention is for controlling a data recording or a data reproducing based on control parameters stored in a first recording medium or a second recording medium. The device includes a storing unit that stores initial parameters indicating initial values of the control parameters in a first storage medium in association with first update parameters obtained by modifying the initial parameters; a difference detecting unit that compares, when second update parameters are stored in a second storage medium, the initial parameters with the second update parameters, and detects a parameter that is different between the initial parameters and the second update parameters; and an initialization unit that initializes the first update parameters based on a result of detection by the difference detecting unit.

A method according to another aspect of the present invention is for controlling a data recording or a data reproducing based on control parameters stored in a first recording medium or a second recording medium. The method includes storing initial parameters indicating initial values of the control parameters in a first storage medium in association with first update parameters obtained by modifying the initial parameters; difference detecting including comparing, when second update parameters are stored in a second storage medium, the initial parameters with the second update parameters, and detecting a parameter that is different between the initial parameters and the second update parameters; and initializing the first update parameters based on a result of detection at the difference detecting.

A computer-readable recording medium according to still another aspect of the present invention stores therein a computer program for controlling a data recording or a data reproducing based on control parameters stored in a first recording medium or a second recording medium. The computer program causes a computer to execute storing initial parameters indicating initial values of the control parameters in a first storage medium in association with first update parameters obtained by modifying the initial parameters; difference detecting including comparing, when second update parameters are stored in a second storage medium, the initial parameters with the second update parameters, and detecting a parameter that is different between the initial parameters and the second update parameters; and initializing the first update parameters based on a result of detection at the difference detecting.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic view of the operations performed when a storage device receives a Mode Select Command with a “With Save” instruction;

FIG. 2 is a first diagram explaining a Drive Ready operation according to this embodiment;

FIG. 3 is a second diagram explaining a Drive Ready operation according to this embodiment;

FIG. 4 is a third diagram explaining a Drive Ready operation according to this embodiment;

FIG. 5 is a fourth diagram explaining a Drive Ready operation according to this embodiment;

FIG. 6 is a schematic view of the construction of the storage device according to this embodiment;

FIG. 7 is a schematic view of a data structure of mode parameters;

FIG. 8 is a schematic view of a data structure of a mode parameter management table;

FIG. 9 is a schematic view of a data structure of mode parameters stored by a disk;

FIG. 10 is a schematic view of a replacement performed by a mode parameter managing unit;

FIG. 11 is a flowchart explaining an operation sequence of the storage device according to this embodiment;

FIG. 12 is a diagram explaining Power On and Drive Ready operations according to the conventional technology;

FIG. 13 is a diagram explaining the operations performed when the Mode Select Command is issued to the storing unit; and

FIG. 14 is a diagram explaining the initialization of mode parameters in to a storage device according to the conventional technology.

### DETAILED DESCRIPTION OF THE PREFERRED EMBODIMENTS

Exemplary embodiments of the present invention are explained in detail below with reference to the accompanying drawings.

An outline of a storage device according to a first embodiment of the present invention will now be described. The storage device according to this embodiment, when mode parameters are stored in a disk, stores a Def value together with a Sav value of the mode parameters. When the mode parameters are read after downloading firmware, or after Drive Ready following Power On, the storage device compares the Def value of the mode parameters in the firmware with the Def value of the mode parameters on the disk, and only those parameters that are different are initialized.

The description of Power On, Drive Ready, mode parameters, and the Cur value and Save value of the mode parameters, is identical to that in “Background of the Invention”, and will therefore be omitted.

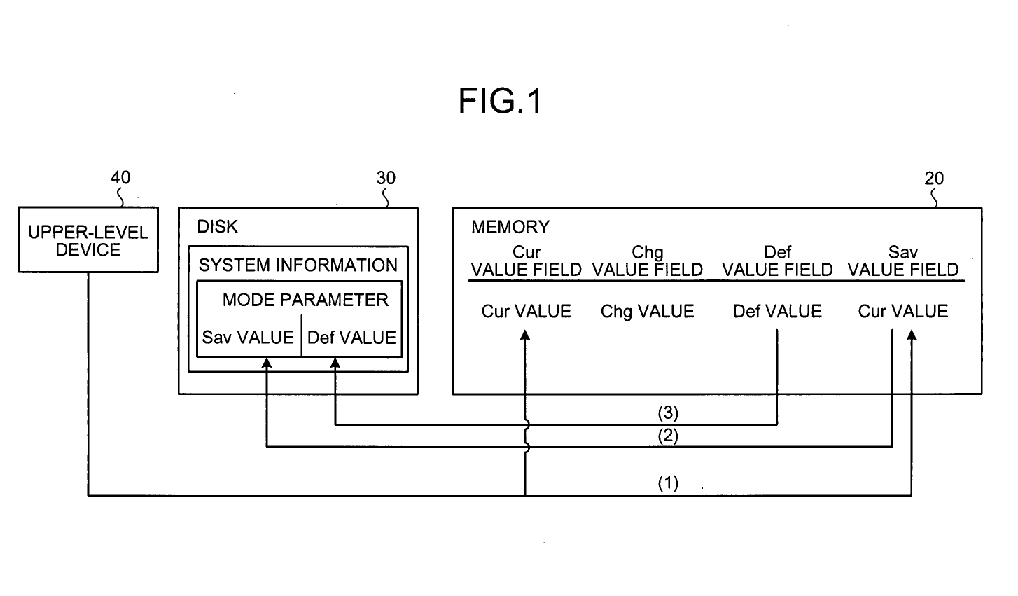

The storage device according to this embodiment will now be described referring to FIG. 1 to FIG. 5. FIG. 1 is a schematic view of the operations performed when the storage device receives a Mode Select Command with the instruction “With Save” (for a description of the Mode Select Command, see “Background of the Invention”). As shown in FIG. 1, when the storage device acquires the Mode Select Command with the instruction “With Save” from the upper-level device 40, the Cur value field is modified to the Cur value, and the Sav value field is modified to the Cur value, in the memory 20 ((1) in FIG. 1.

The storage device then stores the Cur value stored in the Sav value field of the memory 20, in the mode parameters of the disk 30 ((2) of FIG. 1), and stores the Def value stored in the Def value field correspondingly with the Sav value of the mode parameters of the disk 30 ((3) of FIG. 1).

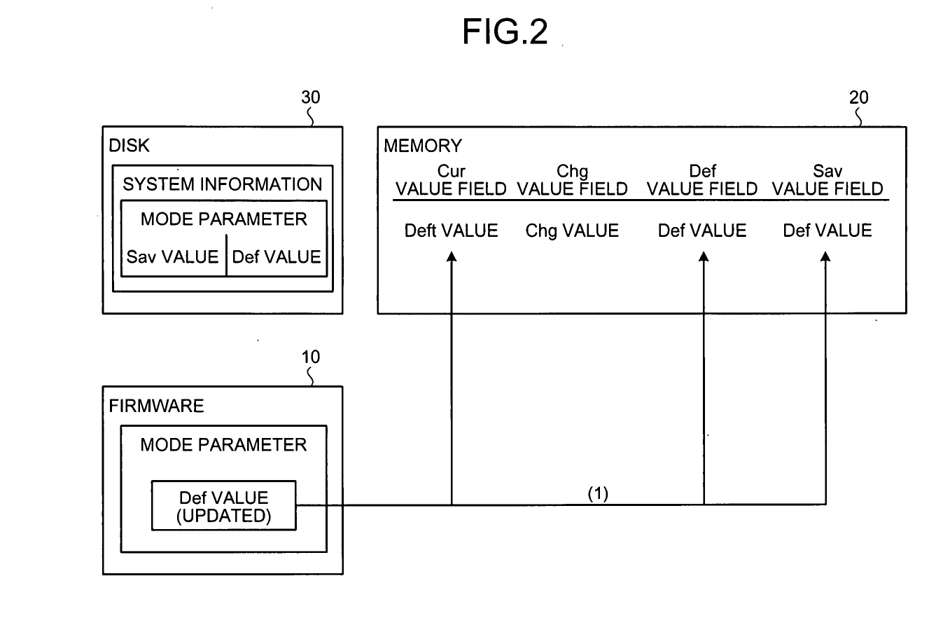

Next, Drive Ready according to this embodiment will be described referring to FIG. 2 to FIG. 5. FIG. 2 to FIG. 5 are diagrams explaining a Drive Ready operation according to this embodiment. As shown in FIG. 2, mode parameters are acquired from a firmware 10 downloaded to a Flash Rom (not shown), and the Def value of the acquired mode parameters is stored in a Cur value field, Def value field and Sav value field of the memory 20 ((1) of FIG. 2).

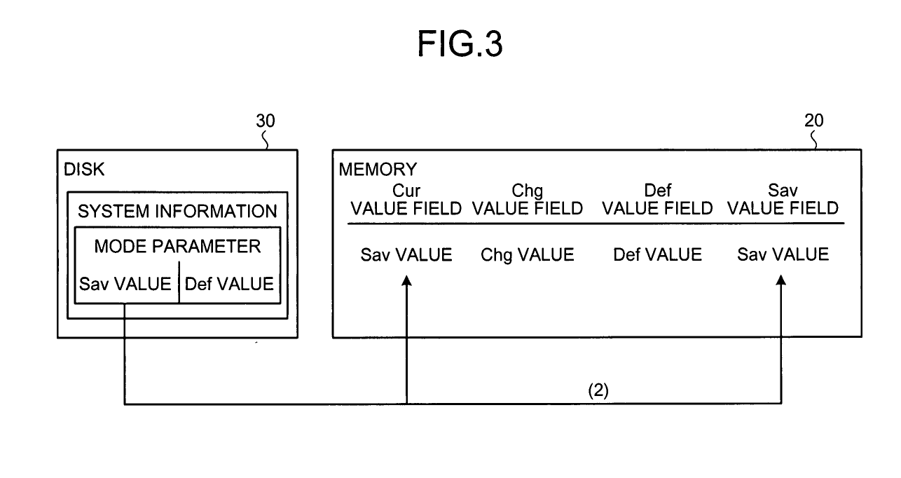

When the disk 30 has reached a steady rotation velocity, the storage device performs Drive Ready, reads the Sav value of the mode parameters stored on the disk 30, and stores the read Sav value in the Cur value field and Sav value field of the memory 20 ((2) of FIG. 3).

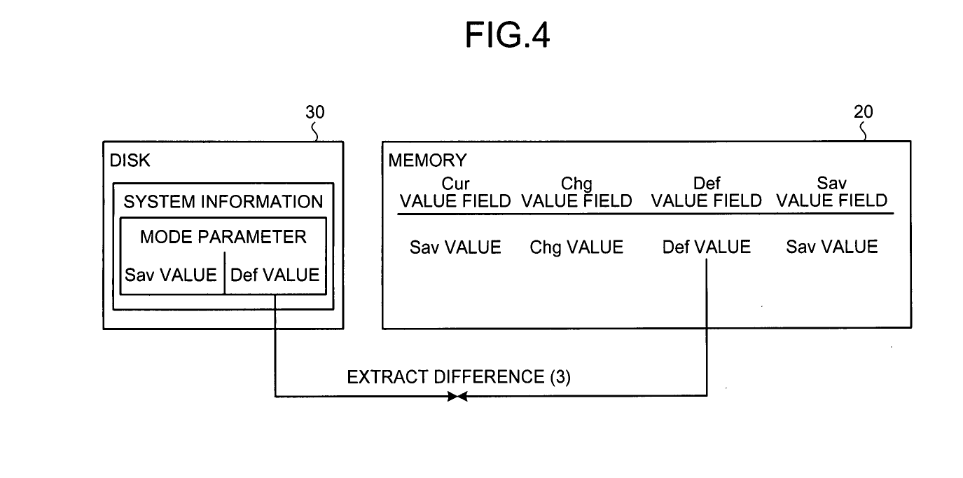

The Def value of the mode parameters read from the disk 30 is then compared with the Def value stored in the Def value field of the memory 20 (corresponding to the Def value of the firmware), and the difference is extracted ((3) in FIG. 4).

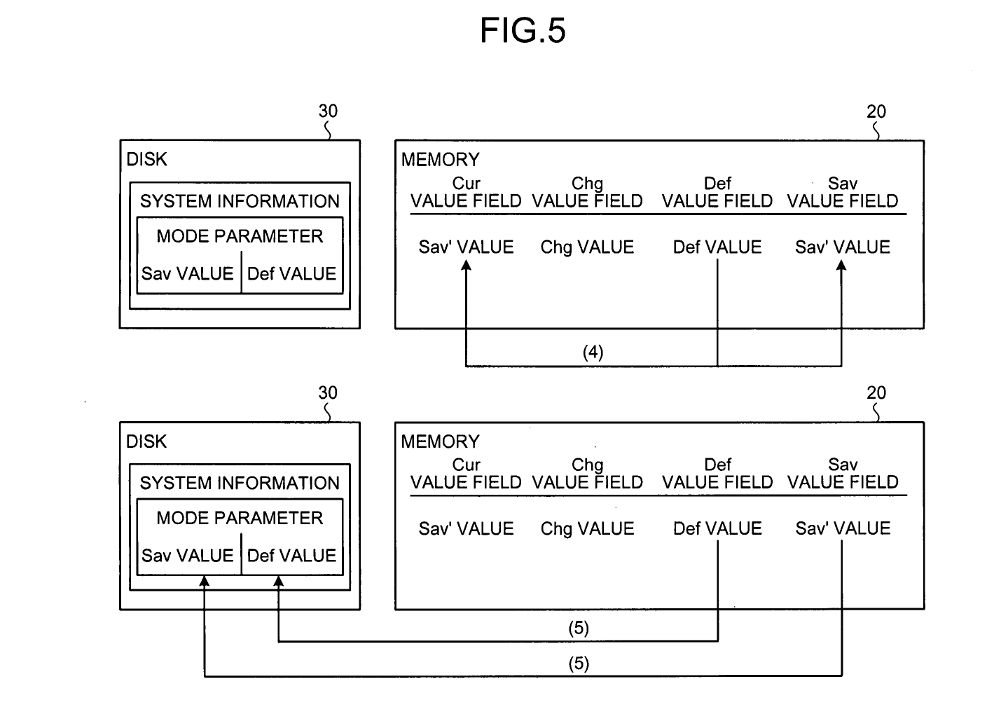

The storage device, among the mode parameters stored in the Cur value field and Sav value field, replaces only specific parameters for which a difference was extracted, by the Def value in the Def value field ((4) of FIG. 5).

Next, the storage device, when the Cur value and the Sav value are replaced, stores the Def value in the Def value field and a Sav′ value in the Sav value field (Sav value for which only specific parameters are initialized) correspondingly with each other on the disk 30 ((5) of FIG. 5).

Hence, the storage device of the embodiment stores not only the Sav value of the mode parameters on the disk 30, but also the stores the Def value together therewith. Consequently, after downloading firmware or during Drive Ready after Power On, these are compared with the initial values in the firmware when the mode parameters are read as system information, and by extracting the differences, modifications of the initial values can be identified so that only those parameters for which there is a difference are initialized.

Therefore, if a format is changed or initial values are modified for the same client, no special firmware is required to forcibly initialize the mode parameters, to make it impossible to modify specific mode parameters, or to perform a modification that determines whether to initialize mode parameters by a customization code.

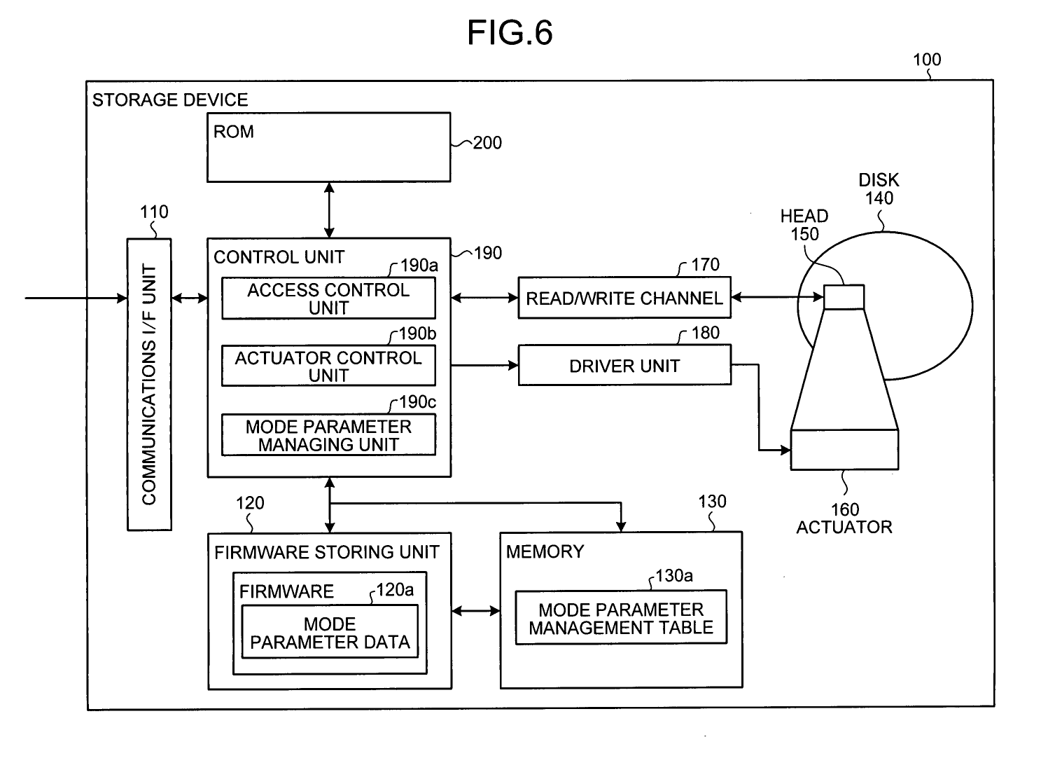

Next, the construction of a storage device 100 according to this embodiment will be described. FIG. 6 is a schematic view of the construction of the storage device according to this embodiment. As shown in the diagram, the storage device 100 comprises a communications interface (I/F) unit 110, a firmware storing unit 120, a memory 130, a disk 140, a head 150, an actuator 160, a read/write channel 170, a driver unit 180, a control unit 190, and a ROM 200.

Among these, the communications I/F unit 110 performs data communication with an upper-level device (not shown) using a predetermined communications protocol. The firmware storing unit 120 stores firmware. This firmware, as shown in FIG. 6, includes a mode parameter data 120a.

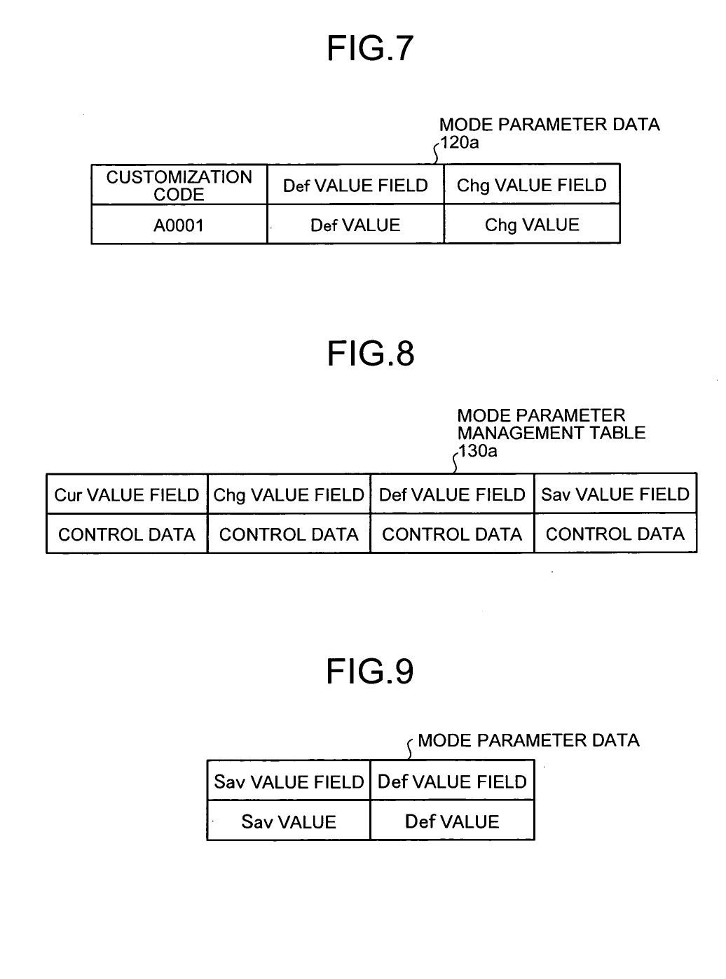

The mode parameter data 120a contains data (mode parameters) for example specifying the number of retries to be performed during a read error, and whether to perform caching during read. FIG. 7 is a schematic view of an example of the data structure of the mode parameter data 120a. As shown in the diagram, the mode parameter data 120a has a customization code that identifies the firmware version or the like, a Def value field that stores an initial value (Def value) of a mode parameter, and a Chg value field that stores a Chg value of a mode parameter.

The memory 130 stores the various data used by the control unit 190, and stores a mode parameter management table 130a having a close relationship with the present invention. FIG. 8 is a schematic view of an example of the data structure of the mode parameter management table 130a. As shown in the diagram, the mode parameter management table 130a has a Cur value field, Chg value field, Def value field and Sav value field.

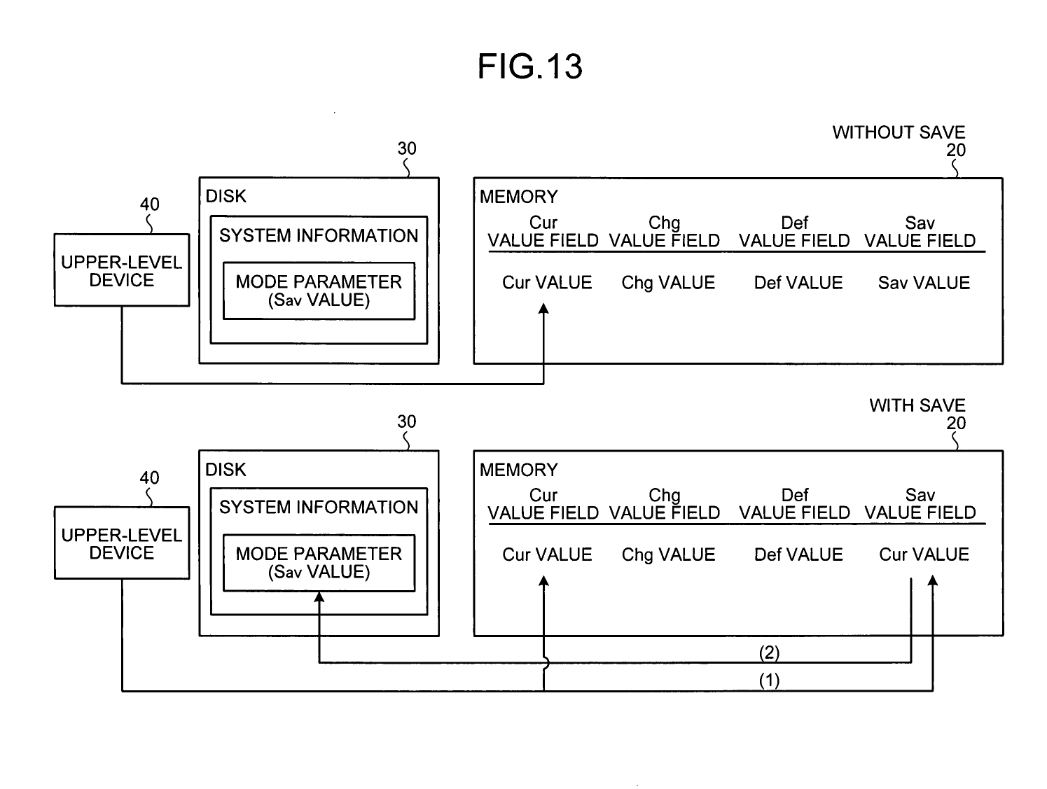

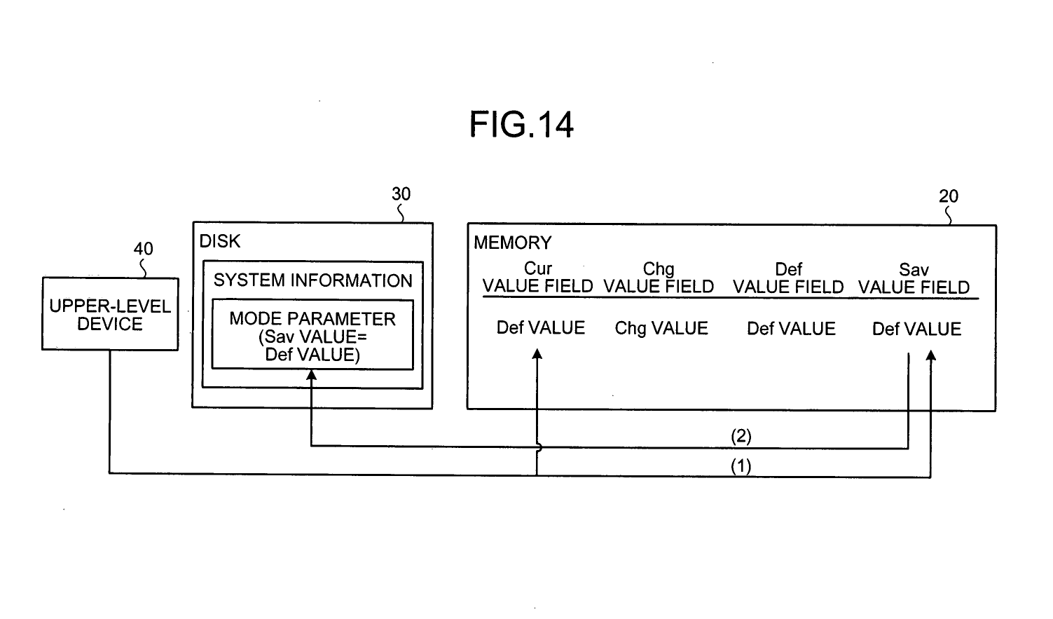

Among these, the Cur value field is a field that stores control data (the Def value, Cur value and Sav value described in FIG. 12 to FIG. 14 and FIG. 1 to FIG. 5). The control unit 190 performs operations related to read and write using the control data stored in the Cur value field.

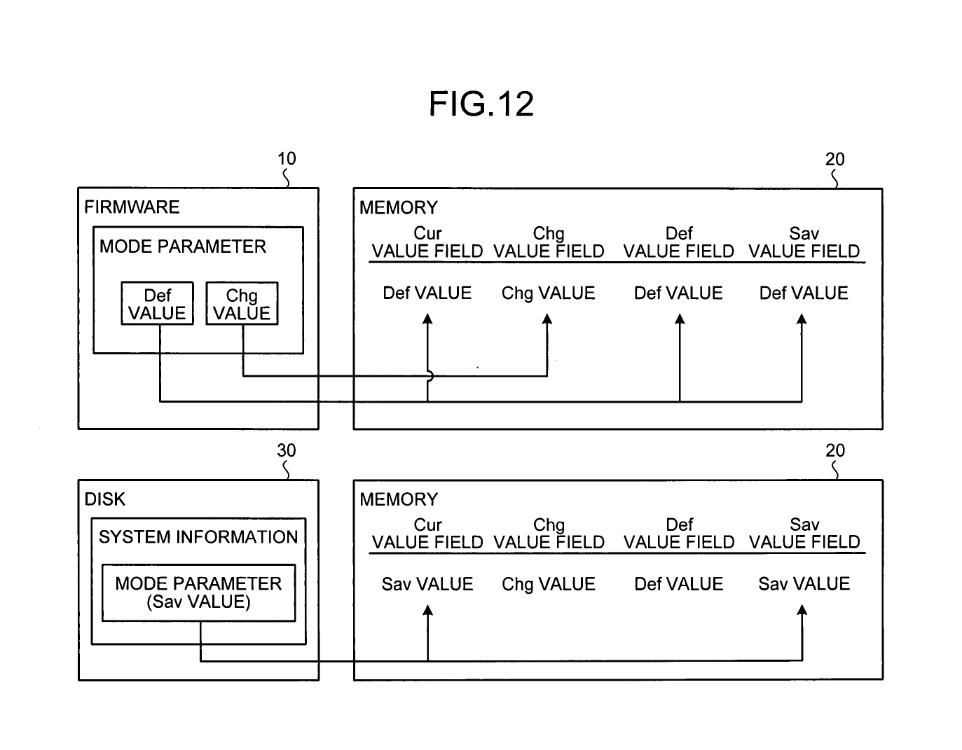

The Chg value field is a field that stores control data (Chg value of the mode parameters described in FIG. 12 to FIG. 14). The Def value field is a field that stores control data (Def value of the mode parameters shown in FIG. 7). The Sav value field is a field that stores control data (Def value, Cur value and Sav value of the mode parameters described in FIG. 12 to FIG. 14, and FIG. 1 to FIG. 5).

The disk (magnetic disk) 140 is a circular storage medium comprising a magnetic thin film formed on a substrate, and it stores various data such as user data and control data. In particular, the disk 140 stores mode parameter data that have a close relationship with this embodiment.

FIG. 9 is a schematic view of one example of the data structure of the mode parameter data stored on the disk. As shown in the diagram, the mode parameter data stored on the disk 140 comprises a Sav value field that stores the Sav value of the mode parameters and a Def value field that stores the Def value of the mode parameters.

Returning now to FIG. 6, the head 150 performs data read/write to and from the disk 140. The head 150 reads a servo signal that controls a track position or the like, mode parameter data (FIG. 9), and user data from the disk 140, and outputs the read data to the read/write channel 170.

The actuator 160 has a voice coil motor (VCM), and moves the head 150 according to a control current output by the driver unit 180. The read/write channel 170 acquires a servo signal, user data and the parameters from the head 150, and outputs the acquired servo signal, user data and mode parameters to the control unit 190.

The driver unit 180 outputs a control current to the actuator 160 in response to a control command from the control unit 190, and controls the movement of the head 150. The driver unit 180 also outputs a control current to a spindle motor (not shown), and controls the rotation of the disk 140.

The control unit 190 is provided with programs specifying various control procedures and an internal memory that stores control data. For this purpose, to perform various operations having a close relationship with the present invention, it includes an access control unit 190a, an actuator control unit 190b, and a mode parameter managing unit 190c as shown in FIG. 6.

Among these, the access control unit 190a, when user data to be stored is acquired from the upper-level device, outputs the acquired user data to the read/write channel 170, and stores the user data on the disk 140. The access control unit 190a, when user data to be read by the upper-level device is acquired from the read/write channel 170, also outputs the acquired user data to the upper level device.

The access control unit 190a also controls operation by looking up control data (FIG. 8) in the Cur value field of the mode parameter management table 130a stored in the memory 130. For example, if the number of retries to be performed when a read error of control data stored in the Cur value field occurs is N (N is a natural integer), the access control unit 190a performs N retries during a read error.

The actuator control unit 190b outputs a control command to the driver unit 180, and performs movement control of the head 150. The actuator control unit 190b also performs rotation control of the disk 140.

The mode parameter managing unit 190c manages the mode parameter table stored in the memory 130. Hereafter, the operation of the mode parameter managing unit 190c will be described referring to FIG. 1 to FIG. 5.

(When a Mode Select Command (“With Save”) is Received: Corresponds to FIG. 1)

First, the mode parameter managing unit 190c, when a Mode Select Command with a “With Save” indication is received from the upper-level device, the mode parameter management table 130a modifies the Cur value field of the mode parameter management table 130a to the Cur value of the mode parameters, and modifies the Sav value field to the Cur value of the mode parameters.

The mode parameter managing unit 190c then stores the Cur value stored in the Sav value field of the mode parameter management table 130a, in the mode parameters on the disk 140, and stores the Def value stored in the Def value field correspondingly with the Sav value of the mode parameters on the disk 140.

(Drive Ready: Corresponds to FIG. 2 to FIG. 5)

The mode parameter managing unit 190c, during Power On, acquires the mode parameter data 120a from the firmware stored in the firmware storing unit 120, and stores the Def value of the acquired mode parameter in the Cur value field, Def value field and Sav value field of the mode parameter management table 130a.

When the disk 140 has reached a steady rotation velocity, Drive Ready of the mode parameter managing unit 190c is performed, the Sav value of the mode parameters stored on the disk 140 is read, and the read Sav value is stored in the Cur value field and Sav value field of the mode parameter management table 130a.

The mode parameter managing unit 190c then compares the Def value of the mode parameter read from the disk 140 with the Def value stored in the Def value field of the mode parameter management table 130a, and extracts the difference.

The mode parameter managing unit 190c, among the Sav values of the mode parameters stored in the Cur value field and the Sav value field of the mode parameter management table 130a, replaces only specific parameters for which a difference was extracted, by the Def value in the Def value field.

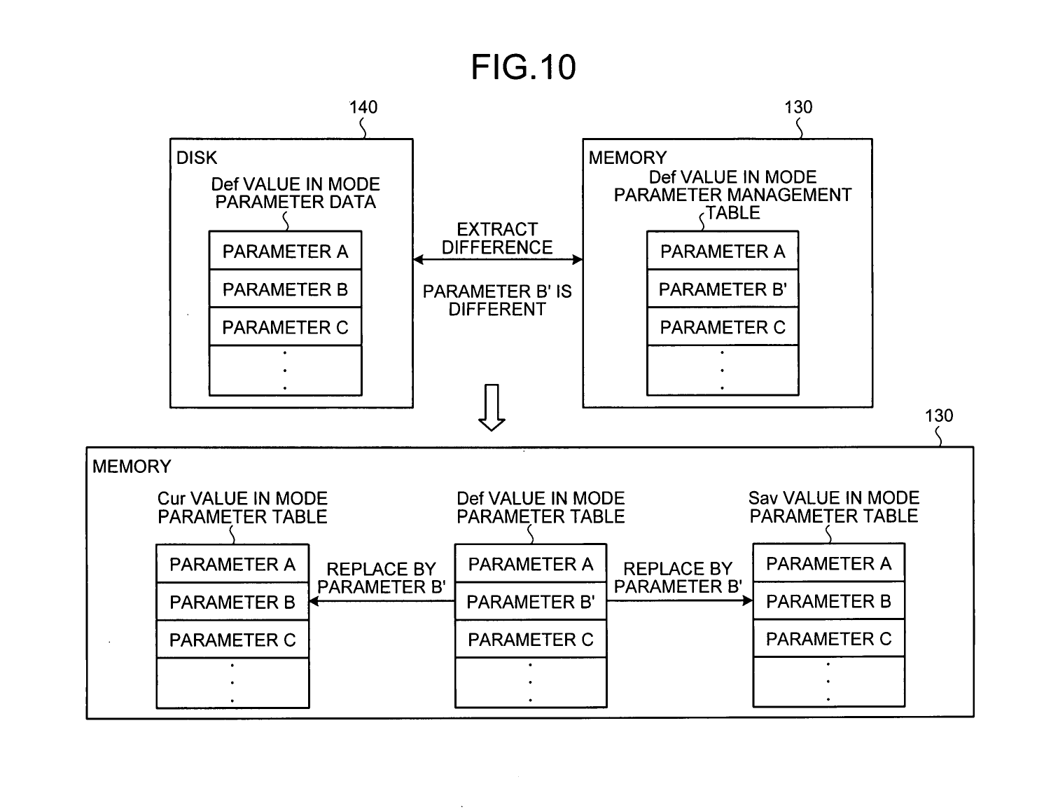

FIG. 10 is a diagram showing a replacement by the mode parameter managing unit 190c. As shown in the upper part of this diagram, the Def value of the mode parameters read from the disk 140 is compared with the Def value stored in the Def value field of the mode parameter management table 130a, and when the difference is extracted, it is found that a parameter B′ is different.

Hence, as shown in the lower part of FIG. 10, the mode parameter managing unit 190c replaces only the different parameter B′ by a parameter B in the Cur value field and Sav value field of the mode parameter management table 130a.

The mode parameter managing unit 190c, when the Cur value field and Sav value field of the mode parameter management table 130a are replaced, stores the Def value stored in the Def value field and the Sav′ value stored in the Sav value field (Sav value for which only specific parameters were initialized) together on the disk 140. The ROM 200 stores data and programs required for various operations by the control unit 190.

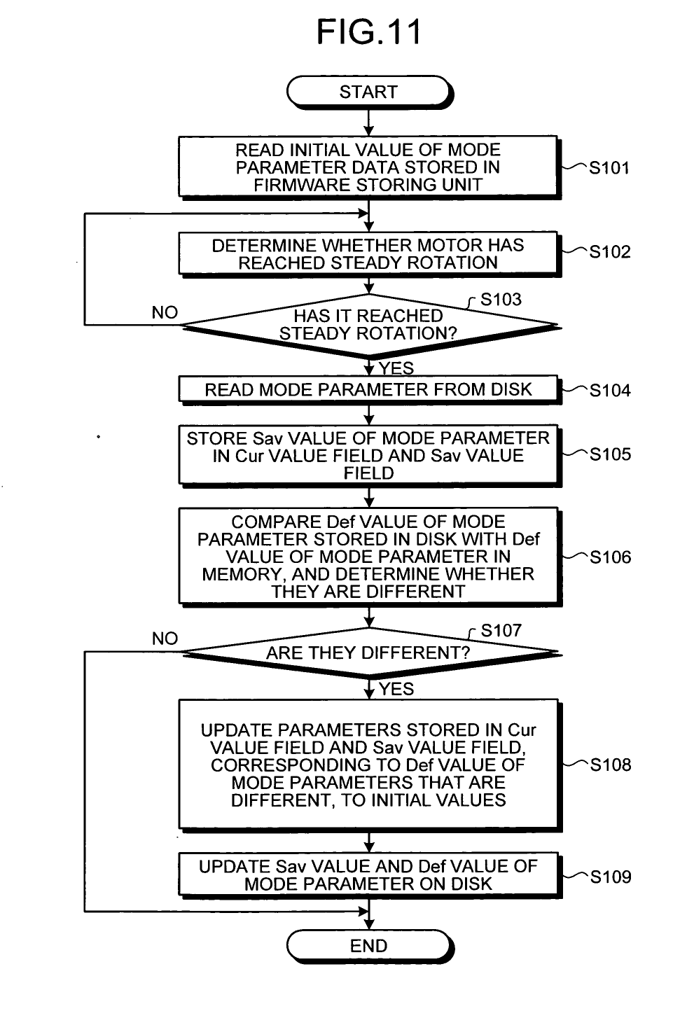

The operation sequence of the mode parameter managing unit 190c according to this embodiment will now be described. FIG. 11 is a flow chart explaining the operation sequence of the storage device according to this embodiment. As shown in the diagram, in the storage device according to this embodiment, the mode parameter managing unit 190c reads the initial value of the mode parameter data 120a stored in the firmware storing unit 120, and stores this in the mode parameter management table 130a (step S101).

The mode parameter managing unit 190c then determines whether the motor (spindle motor that rotates the disk 140) has reached a steady rotation velocity (Mrpm (rounds per minute), M is a positive integer) (step S102), and if the rotation velocity is less than the steady rotation velocity (step S103, No), the routine proceeds to the step S102.

On the other hand, if the motor has reached the steady rotation velocity (step S103, Yes), the mode parameters are read from the disk 140 (step S104), and the Sav value of the mode parameters is stored in the Cur value field and Sav value field of the memory 130 (step S105).

The mode parameter managing unit 190c compares the Def value of the mode parameters stored on the disk with the Def value of the mode parameters in the memory 130, and determines whether there is a difference (step S106).

When there is no difference (step S107, No), the storage device 100 terminates Drive Ready. On the other hand, when there is a difference (step S107, Yes), the mode parameter managing unit 190c sets different parameters of the mode parameters stored in the Cur value field and Sav value field corresponding to the Def values of only the different parts to initial values (step S108), and updates the Sav value and Def value of the mode parameters on the disk 140 (step S109).

Hence, the mode parameter managing unit 190c compares the Def value of the mode parameters on the disk 140 with the Def value of the mode parameters in the firmware storing unit 120, and sets only those parameters that are different to their initial values, so unnecessary operations to update the mode parameters can be eliminated.

As described above, the storage device 100 according to this embodiment, when it stores mode parameters on the disk 140, stores not only the Sav value but also the Def value of the mode parameters. Therefore the storage device 100, when reading mode parameters after downloading firmware or during Drive Ready after Power On, compares the Def value of the mode parameters in the firmware with the Def value of the mode parameters on the disk 140, and initializes only those parameters that are different, so unnecessary operations to update the mode parameters are eliminated, and the burden on the client is lessened.

Also, in the storage device 100 of this embodiment, even if a format was changed or an initial value was modified for the same client, no special firmware is required to forcibly initialize mode parameters, to make it impossible to modify specific mode parameters, or to perform a modification that determines whether to initialize mode parameters by a customization code.

The various operations described in the aforesaid embodiments may be performed also by a storage device (computer) that executes a previously prepared program. In the example shown in FIG. 6, various programs that perform the aforesaid operations are stored in the ROM 200, and when the control unit 190 reads these programs recorded on the ROM 200, operations that implement the functions of its constituent units (the access control unit 190a, the actuator control unit 190b, the mode parameter managing unit 190c) are started.

These programs are not necessarily initially stored in a ROM. For example, they may be stored on a “movable physical medium” such as a flexible disk (FD), CD-ROM, DVD disk, magneto optical disk or IC card inserted in a computer, whereupon “another computer (or server)” connected to the computer via a public circuit, the Internet, a LAN or a WAN, reads these programs and executes them.

Some embodiments of the invention have been described, but it should be understood that the invention is not to be construed as being limited in anyway thereby, various modifications being possible within the scope and spirit of the appended claims.

All or part of the operations described in the embodiments as being executed automatically may be performed manually, or alternatively, all part of the operations described as being performed manually may be performed automatically.

Information containing operation sequences, control sequences, specific names, data and parameters shown in the specification and drawings can be freely modified unless otherwise specified.

Moreover, the various component elements of the devices shown in the drawings do not necessarily exist as physical entities. Specifically, the separation or integration of these devices is not limited to those shown in the drawings, and all or part thereof may be physically or functionally separated or integrated in arbitrary units according to load and usage.

As described above, according to one aspect of the present invention, among first updated parameters, only those parameters for which initial parameters and second update parameters are different, are initialized. Hence, even if a format is modified and an initial value is modified for the same client, no special firmware is required to forcibly initialize mode parameters, to make it impossible to modify specific mode parameters, or to perform a modification that determines whether to initialize mode parameters by a customization code.

Furthermore, according to another aspect of the present invention, initialized first updated parameters are stored correspondingly with initial parameters in a first storage medium, so updating of mode parameters can be performed efficiently.

Moreover, according to still another aspect of the present invention, second update parameters are stored in the first storage medium as the initial parameters, so updating of mode parameters on the next occasion can be performed without fail.

Furthermore, according to still another aspect of the present invention, initial parameters having the initial values of control parameters and first update parameters that are modifications of these initial parameters are stored correspondingly with each other in the first storage medium. When second update parameters that modify the control parameters are stored in a second storage medium, the initial parameters are compared with the second update parameters to detect those parameters that are different, and the first update parameters are initialized based on the detection result. Hence, unnecessary operations for updating mode parameters can be eliminated, and the burden on the client can be lessened.

Moreover, according to still another aspect of the present invention, among first updated parameters, only those parameters for which the initial parameters and second update parameters are different, are initialized, so even if a format is changed and the initial values are modified for the same client, no special firmware is required to forcibly initialize mode parameters, to make it impossible to modify specific mode parameters, or to perform a modification that determines whether to initialize mode parameters by a customization code.

Furthermore, according to still another aspect of the present invention, the second update parameters are stored in the first storage medium as initial parameters, so updating of mode parameters on the next occasion can be performed without fail.

Moreover, according to still another aspect of the present invention, unnecessary operations for updating mode parameters can be eliminated, and the burden on the client can be lessened. Also, by incorporating the storage device (control device) of the invention in a system, the system does not have to download special firmware, so the system can perform other operations more smoothly.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A device for controlling a data recording or a data reproducing based on control parameters stored in a first recording medium or a second recording medium, the device comprising:
a storing unit that stores initial parameters indicating initial values of the control parameters in a first storage medium in association with first update parameters obtained by modifying the initial parameters;
a difference detecting unit that compares, when second update parameters are stored in a second storage medium, the initial parameters with the second update parameters, and detects a parameter that is different between the initial parameters and the second update parameters; and
an initialization unit that initializes the first update parameters based on a result of detection by the difference detecting unit.

2. The device according to claim 1, wherein the initialization unit initializes a parameter of the first updated parameters corresponding to the parameter that is different between the initial parameters and the second update parameters.

3. The device according to claim 1, wherein the initialization unit stores initialized first update parameters in the first storage device in association with the initial parameters.

4. The device according to claim 1, wherein the initialization unit stores the second update parameters in the first storage medium as the initial parameters.

5. A method of controlling a data recording or a data reproducing based on control parameters stored in a first recording medium or a second recording medium, the method comprising:
storing initial parameters indicating initial values of the control parameters in a first storage medium in association with first update parameters obtained by modifying the initial parameters;
difference detecting including
comparing, when second update parameters are stored in a second storage medium, the initial parameters with the second update parameters, and
detecting a parameter that is different between the initial parameters and the second update parameters; and
initializing the first update parameters based on a result of detection at the difference detecting.

6. The method according to claim 5, wherein the initializing includes initializing a parameter of the first updated parameters corresponding to the parameter that is different between the initial parameters and the second update parameters.

7. The method according to claim 5, wherein the initializing includes storing initialized first update parameters in the first storage device in association with the initial parameters.

8. The method according to claim 5, wherein the initializing includes storing the second update parameters in the first storage medium as the initial parameters.

9. A computer-readable recording medium that stores therein a computer program for controlling a data recording or a data reproducing based on control parameters stored in a first recording medium or a second recording medium, the computer program causing a computer to execute:
storing initial parameters indicating initial values of the control parameters in a first storage medium in association with first update parameters obtained by modifying the initial parameters;
difference detecting including
comparing, when second update parameters are stored in a second storage medium, the initial parameters with the second update parameters, and
detecting a parameter that is different between the initial parameters and the second update parameters; and
initializing the first update parameters based on a result of detection at the difference detecting.

10. The computer-readable recording medium according to claim 9, wherein the initializing includes initializing a parameter of the first updated parameters corresponding to the parameter that is different between the initial parameters and the second update parameters.

11. The computer-readable recording medium according to claim 9, wherein the initializing includes storing initialized first update parameters in the first storage device in association with the initial parameters.

12. The computer-readable recording medium according to claim 9, wherein the initializing includes storing the second update parameters in the first storage medium as the initial parameters.
